(19) United States
(12) Patent Application Publication
(10) Pub. No.: US 2026/0172258 A1
(43) Pub. Date: Jun. 18, 2026

(54) BLOCKCHAIN MONITORING METHOD AND APPARATUS, DEVICE, AND STORAGE MEDIUM

(71) Applicant: IEIT SYSTEMS CO., LTD., Jinan, Shandong (CN)

(72) Inventors: Qunyang LIN, Suzhou, Jiangsu (CN); Chuang ZHANG, Suzhou, Jiangsu (CN); Zhiyong XIE, Suzhou, Jiangsu (CN)

(73) Assignee: IEIT SYSTEMS CO., LTD., Jinan, Shandong (CN)

(21) Appl. No.: 18/724,507

(22) PCT Filed: Nov. 9, 2022
(86) PCT No.: PCT/CN2022/130982

§ 371 Date: Jun. 26, 2024

(30) Foreign Application Priority Data
Jun. 30, 2022 (CN) 202210754376.6

(51) Int. Cl. H04L 9/32; H04L 9/00; H04L 9/40

(52) U.S. Cl. CPC H04L 9/3236; H04L 9/50; H04L 63/0428

(57) ABSTRACT

The present disclosure relates to the technical field of blockchains, and discloses a blockchain monitoring method and apparatus, a device, and a storage medium, applied to a monitoring node deployed in each of blockchains. The method includes: receiving rule information sent by a monitoring center, and determining a corresponding detection algorithm according to a detection means defined in the rule information; acquiring on-chain block data, and performing detection on the on-chain block data by using the detection algorithm, so as to determine whether the on-chain block data meets a compliance condition defined in the rule information. In the present disclosure, a monitoring center arranged outside a blockchain exchanges data with a monitoring node deployed in the blockchain, rule information is supervised and distributed in a unified manner by the monitoring center, and the monitoring node is adapted to the corresponding blockchain.

### CROSS-REFERENCE TO RELATED APPLICATION

The present application is a National Stage Application of PCT International Application No.: PCT/CN2022/130982 filed on Sep. 11, 2022, which claims priority to Chinese Patent Application 202210754376.6, filed in the China National Intellectual Property Administration on Jun. 30, 2022, the disclosure of which is incorporated herein by reference in its entirety.

### TECHNICAL FIELD

The present disclosure relates to the technical field of blockchains, and in particular to a blockchain monitoring method and apparatus, a device, and a storage medium.

### BACKGROUND

Blockchain technology has distinctive technical features, including decentralization, distributed storage, data openness and transparency, immutability, and traceability. Based on these technical features, data on a blockchain is labeled as “trusted”. Untrusted nodes on the blockchain share the same data ledger and can securely exchange data freely through a consensus algorithm, thereby achieving “self-governance” of a system without third-party intervention. The blockchain may be classified into a public chain, a private chain, and an alliance chain according to access and management rights. The public chain is open to anyone or any entity without the need for registration, allowing for anonymous participation with no official organization or management organization. Typical applications include Bitcoin and Ethereum. The private chain controls node joining through central nodes in a small number of regions and is usually established within a company or organization, with the accounting right being owned by a private institution and not open to the outside world. The alliance chain is jointly initiated by several institutions or organizations, and is a multi-centralized system, participants join through authorization, the permissions to read and write data are controlled by authorization, and the system requires supervision, and is suitable for application scenarios involving a wide range of transactions between different main bodies of assets.

At present, the blockchain has been widely used in the fields of digital economy and social governance and provides important technical support. With the implementation and actual use of a blockchain application system, due to the immutability of the blockchain system, data cannot be modified or deleted once the data is on the chain. This feature enables the blockchain to become a channel for the release and dissemination of various false and bad information, and these false or bad information on the chain will cause continuous or even permanent negative impacts, so that there is an urgent need for a secure and reliable technical means to perform supervision on the on-chain data, and remove harmful data timely and efficiently.

Therefore, the above technical problems are urgent to be solved by those skilled in the art.

### SUMMARY

In view of this, the purpose of the present disclosure is to provide a blockchain monitoring method and apparatus, a device, and a storage medium, applied to a monitoring node deployed in each of blockchains to solve the problem of incapability of achieving high-adaptability data supervision between heterogeneous blockchains. The specific solution is as follows:

a first aspect of the present disclosure provides a blockchain monitoring method, applied to a monitoring node deployed in each of blockchains, including the following operations;

rule information sent by a monitoring center is received, and a corresponding detection algorithm is determined according to a detection means defined in the rule information;

on-chain block data is acquired, and detection is performed on the on-chain block data by using the detection algorithm, so as to determine whether the on-chain block data meets a compliance condition defined in the rule information.

In some embodiments, the operation that a corresponding detection algorithm is determined according to a detection means defined in the rule information includes the following operation:

the corresponding detection algorithm is determined from a detection algorithm pool deployed on the monitoring node according to the detection means defined in the rule information.

In some embodiments, the operation that detection is performed on the on-chain block data by using the detection algorithm includes the following operation:

a data structure corresponding to the detection algorithm is constructed, and detection is performed on the on-chain block data by using the data structure.

In some embodiments, the operation that rule information sent by a monitoring center includes the following operation:

the rule information and change information sent by the monitoring center are received. The change information represents difference information between the rule information received by the monitoring node this time and rule information received last time;

accordingly, the operation that a data structure corresponding to the detection algorithm is constructed includes the following operation;

a changed detection algorithm is determined according to the change information, and the data structure is updated based on the changed detection algorithm.

In some embodiments, after determining whether the on-chain block data meets the compliance condition defined in the rule information, the method further includes the following operation:

if the on-chain block data does not meet the compliance condition, a corresponding non-compliance record is generated according to a detection result, and the non-compliance record is sent to the monitoring center, so that the monitoring center saves the non-compliance record in a local storage system.

In some embodiments, the operation that detection is performed on the on-chain block data by using the detection algorithm, so as to determine whether the on-chain block data meets a compliance condition defined in the rule information includes the following operation:

detection is performed on on-chain data and off-chain data of the on-chain block data by using the detection algorithm, respectively, and if at least one of the on-chain data and the off-chain data does not meet the compliance condition, it is determined that the on-chain block data does not meet the compliance condition.

In some embodiments, the blockchain monitoring method further includes the following operation:

the rule information is sent to a monitoring agent software deployed at a preset position of each of block nodes in the blockchain where the monitoring node is located, so that each monitoring agent software determines the corresponding detection algorithm according to the detection means defined in the rule information and performs detection on the on-chain data sent to a client by the block node where the monitoring agent software is located by using the detection algorithm, so as to determine whether the on-chain data meets the compliance condition defined in the rule information.

In some embodiments, the preset position includes at least one running device of the block node or at least one device connected to an external network in a network where the block node is located.

In some embodiments, the operation of determining whether the on-chain block data meets the compliance condition defined in the rule information includes the following operation:

it is determined whether at least one the on-chain data and the off-chain data contains a target text defined in the rule information according to a detection result, and if at least one the on-chain data and the off-chain data contains the target text, it is determined that at least one of the on-chain data and the off-chain data does not meet the compliance condition.

In some embodiments, after determining that at least one of the on-chain data and the off-chain data does not meet the compliance condition, the method further includes the following operation:

when the data that does not meet the compliance condition includes the off-chain data, a resource identifier corresponding to the off-chain data is added to the target text of the rule information, so that the monitoring agent software determines whether the on-chain data contains the resource identifier added to the target text according to the detection result, and if the on-chain data contains the resource identifier, determines that the on-chain data does not meet the compliance condition.

In some embodiments, after determining that the on-chain data does not meet the compliance condition, the method further includes the following operation:

the monitoring agent software performs processing on the on-chain data that does not meet the compliance condition according to a processing means defined in the rule information, so that a corresponding block node sends a processed on-chain data to the client.

In some embodiments, the blockchain monitoring method further includes the following operations:

the monitoring agent software intercepts a response data packet by means of a function hook and performs decryption on the response data packet, the response data packet is a response of the block node where the monitoring agent software is located to a data request of the client;

the monitoring agent software performs parsing on the decrypted response data packet to perform detection on the parsed response data packet by using the detection algorithm.

In some embodiments, the operation that the monitoring agent software performs parsing on the decrypted response data packet further includes the following operation:

the monitoring agent software determines a block protocol of the decrypted response data packet, and determines a corresponding block parsing module according to the block protocol, so as to parse the decrypted response data packet by using the block parsing module.

A second aspect of the present disclosure provides a blockchain monitoring apparatus, applied to a monitoring node deployed in each of blockchains, including a receiving and determining module and a detection and determination module.

The receiving and determining module is configured to receive rule information sent by a monitoring center, and determine a corresponding detection algorithm according to a detection means defined in the rule information.

The detection and determination module is configured to acquire on-chain block data, and perform detection on the on-chain block data by using the detection algorithm, so as to determine whether the on-chain block data meets a compliance condition defined in the rule information.

A third aspect of the present disclosure provides an electronic device, including a processor and a memory. The memory is configured to store a computer program, and the computer program is loaded and executed by the processor to implement the aforementioned blockchain monitoring method.

A fourth aspect of the present disclosure provides a computer non-volatile readable storage medium, in which a computer executable instruction is stored, and the executable instruction is loaded and executed by a processor to implement the aforementioned blockchain monitoring method.

In the present disclosure, the monitoring nodes deployed in the blockchains first receive the rule information sent by the monitoring center, and determine the corresponding detection algorithm according to the detection means defined in the rule information; and then acquire the on-chain block data, and perform detection on the on-chain block data by using the detection algorithm, so as to determine whether the on-chain block data meets the compliance condition defined in the rule information.

### BRIEF DESCRIPTION OF THE DRAWINGS

In order to more clearly illustrate the embodiments of the present disclosure or the technical solutions in the related art, the drawings used in the description of the embodiments or the related art will be briefly described below. It is apparent that the drawings described below are only some embodiments of the present disclosure. Other drawings may further be obtained by those of ordinary skill in the art according to these drawings without creative efforts.

FIG. 1 is a flowchart of a blockchain monitoring method according to the present disclosure.

FIG. 2 is a specific example of a supervision framework for multipleheterogeneous blockchains according to the present disclosure.

FIG. 3 is a specific flowchart of a blockchain monitoring method according to the present disclosure.

FIG. 4 is a specific flowchart of a blockchain monitoring method according to the present disclosure.

FIG. 5 is a specific flowchart of a data monitoring method for a supervision Agent according to the present disclosure.

FIG. 6 is a specific example diagram of message interaction between a supervision node and a supervision Agent according to the present disclosure.

FIG. 7 is a specific flowchart of a blockchain monitoring method according to the present disclosure.

FIG. 8 is a specific flowchart of a data monitoring method for a monitoring node according to the present disclosure.

FIG. 9 is a specific example diagram of message interaction between a monitoring center, a monitoring node, and a monitoring Agent according to the present disclosure.

FIG. 10 is a schematic structural diagram of a blockchain monitoring apparatus according to the present disclosure.

FIG. 11 is a structural diagram of an electronic device for blockchain monitoring according to the present disclosure.

### DETAILED DESCRIPTION OF THE EMBODIMENTS

The technical solutions in embodiments of the present disclosure will be clearly and completely described below in conjunction with the drawings in the embodiments of the present disclosure. It is apparent that the described embodiments are only part of the embodiments of the present disclosure but not all of the embodiments. All other embodiments obtained by those of ordinary skill in the art on the basis of the embodiments in the present disclosure without creative work shall fall within the scope of protection of the present disclosure.

Due to the immutability of a blockchain system, data cannot be modified or deleted once the data is on the chain. This feature enables the blockchain to become a channel for the release and dissemination of various false and bad information, and these false or bad information on the chain will cause continuous or even permanent negative impacts. In the related art, in order to achieve blockchain supervision technology, most methods uses specific types of hash algorithms, special chain structures, filtering before on-chain, or customized modifications to the blockchain system, and the above methods cannot achieve adaptive supervision without making changes to the existing mainstream blockchain system. In view of the above technical defects, the present disclosure provides a blockchain monitoring solution, a monitoring center arranged outside a blockchain exchanges data with a monitoring node deployed in the blockchain, rule information is supervised and distributed in a unified manner by the monitoring center, and the monitoring node is adapted to the corresponding blockchain, so as to adaptively access the blockchain, thereby solving the problem of incapability of achieving high-adaptability data supervision between heterogeneous blockchains, without the need for customized development of data monitoring functions for different blockchains, and universality is high.

FIG. 1 is a flowchart of a blockchain monitoring method according to an embodiment of the present disclosure. Referring to FIG. 1, a blockchain monitoring method, applied to a monitoring node deployed in each of blockchains, includes the following operations.

At S11, rule information sent by a monitoring center is received, and a corresponding detection algorithm is determined according to a detection means defined in the rule information.

In the embodiment, the monitoring center is a supervision platform located outside the blockchain, and at least one monitoring node is connected to the outside monitoring center in each blockchain. It is to be noted that the monitoring center may also be called a supervision center, which is a supervision rule management service program deployed outside the blockchain, and may be a system server program with a common C-S structure, or a super node program that forms a Peer to Peer (P2P) network with the monitoring node. A supervision user inputs the rule information through an interface (such as a RESTful interface) of the supervision center. The rule information is stored on a disk of the supervision center in the form of a database or a file. The rule information, also called a supervision rule, at least needs to define a detection means and a compliance condition.

On this basis, the monitoring center sends the rule information to all the monitoring nodes connected thereto, that is, the monitoring node receives the rule information sent by the monitoring center. One monitoring node is deployed in each blockchain. The monitoring node may be a new block node added to the blockchain, or an improvement on one of the existing block nodes in the blockchain. The improved node has both the functions of the original block node and the monitoring function. The monitoring node then determines the corresponding detection algorithm according to the detection means defined in the rule information. Specifically, the corresponding detection algorithm is determined from a detection algorithm pool deployed on the monitoring node according to the detection means defined in the rule information. The monitoring node may also be called a supervision node, which receives the rule information sent from the monitoring center, and selects an applicable detection algorithm from the detection algorithm pool according to the rule information.

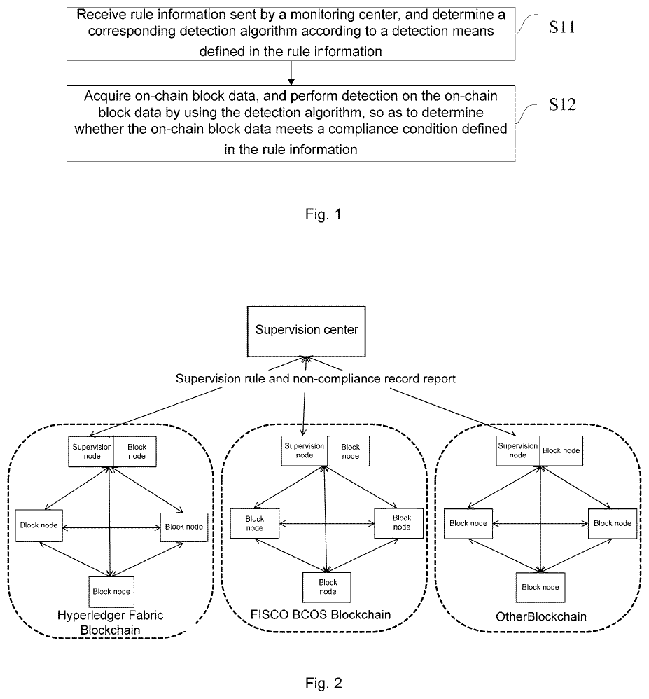

FIG. 2 shows a specific example of a supervision framework for multipleheterogeneous blockchains. The example contains three heterogeneous blockchains based on FISCO BCOS (a financial branch of a BCOS open source platform), Hyperledger Fabric (an open source enterprise-level licensed distributed ledger platform), and other blockchain technologies. All the three blockchains are alliance chains. Three alliance chain systems are implemented based on different alliance chain foundation platforms, and the block data uses different structures, resulting in difficulty in mutual recognition, intercommunication, and interoperability of data between different alliance chains. In the embodiment, on the one hand, at least one monitoring node is connected to the outside monitoring center in each alliance. The supervision center performs data supervision on the alliance chain through the supervision nodes deployed in the alliance chains. The supervision nodes implement the multipleheterogeneous block structures, can adaptively parse and encapsulate block data of different structures, and is a combination of the block nodes of the alliance chain and a supervision function module. This part is an operation performed when the data is on the chain. On the other hand, a supervision Agent associated with the node is deployed in each of other block nodes (except the supervision node) of the alliance chain, and is responsible for intercepting a message sent by the block node to a terminal user (a block node that is not interconnected to the node, that is, a non-Peer node), and performing data detection and mask processing on a message content. This part is an operation performed when returning the data that has been on the chain (on-chain data) to a client, which will be specifically described in the following embodiment.

At S12, on-chain block data is acquired, and detection is performed on the on-chain block data by using the detection algorithm, so as to determine whether the on-chain block data meets a compliance condition defined in the rule information.

In the embodiment, the monitoring node acquires the on-chain block data, and performs detection on the on-chain block data by using the detection algorithm, so as to determine whether the on-chain block data meets the compliance condition defined in the rule information. The detection algorithm may be a text matching algorithm, an image detection algorithm, etc., to perform detection on sensitive words, sensitive images, etc., in the on-chain block data. Generally, after determining the detection algorithm, it is necessary to construct a data structure corresponding to the detection algorithm, and perform detection on the on-chain block data by using the data structure. On this basis, it is determined whether the on-chain block data meets the compliance condition defined in the rule information according to a detection result. The compliance condition may be a condition such as detecting that the specified sensitive words are not contained by means of the detection algorithm. At this time, compliance means that the supervision rule is not hit, which is not limited in the embodiment.

Further, in a case where the monitoring node has already constructed the data structure, when the on-chain block data is acquired for detection, there is no need to construct the data structure of the detection algorithm from scratch again. The data structure needs to be constructed only for the part of the detection algorithm that is changed, and needs not be repeatedly constructed for those that are not changed. Therefore, when issuing the rule to the monitoring node, the monitoring center needs to issue complete rule information and corresponding change information at the same time. That is, the monitoring node receives the rule information and the change information sent by the monitoring center. The change information represents difference information between the rule information received by the monitoring node this time and rule information received last time. Then the monitoring node determines a changed detection algorithm according to the change information, and updates the data structure based on the changed detection algorithm.

In a case where all the rule information in the monitoring center is cached on the monitoring node, when a new rule is added, the monitoring center only needs to send a rule adding message to all the monitoring nodes, and when the existing rule is changed or deleted, the monitoring center only needs to send a rule update message to all the monitoring nodes. In this way, the monitoring node updates the cached rule information accordingly to be consistent with the monitoring center.

It can be seen that, in the embodiment of the present disclosure, the monitoring nodes deployed in the blockchains first receive the rule information sent by the monitoring center, and determine the corresponding detection algorithm according to the detection means defined in the rule information; and then acquire the on-chain block data, and perform detection on the on-chain block data by using the detection algorithm, so as to determine whether the on-chain block data meets the compliance condition defined in the rule information. In the embodiment of the present disclosure, the monitoring center arranged outside the blockchain exchanges data with the monitoring node deployed in the blockchain, the rule information is supervised and distributed in a unified manner by the monitoring center, and the monitoring node is adapted to the corresponding blockchain, so as to adaptability access the blockchain, thereby solving the problem of incapability of achieving high-adaptability data supervision between heterogeneous blockchains, without the need for customized development of data monitoring functions for different blockchains and universality is high.

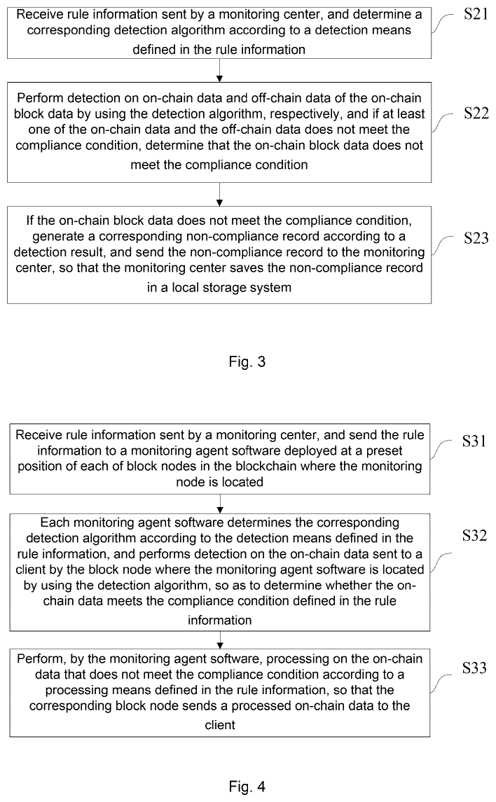

FIG. 3 is a specific flowchart of a blockchain monitoring method according to an embodiment of the present disclosure. Referring to FIG. 3, the blockchain monitoring method, applied to a monitoring node deployed in each of blockchains, includes the following operations.

At S21, rule information sent by a monitoring center is received, and a corresponding detection algorithm is determined according to a detection means defined in the rule information.

In the embodiment, the specific process of the above S21 may refer to the corresponding contents disclosed in the foregoing embodiments, which will not be elaborated here.

At S22, detection is performed on on-chain data and off-chain data of the on-chain block data by using the detection algorithm, respectively, and if at least one of the on-chain data and the off-chain data does not meet the compliance condition, it is determined that the on-chain block data does not meet the compliance condition.

In the embodiment, the monitoring center performs detection on the on-chain data and the off-chain data of the on-chain block data by using the detection algorithm, respectively. It is understandable that a storage means of the blockchain data is quite different from that of conventional network applications, and is classified into on-chain data and off-chain data. Because the on-chain storage space of the blockchain is extremely precious and limited, if the data content is directly put into the blockchain, all the data is transparent and queryable, and cannot be tampered. However, the direct consequences of this means is that the data precipitated on the chain becomes larger and larger, and if the content itself is a file (such as a picture, a video, or a (Portable Document Format (PDF)), the storage overhead on the chain may be quickly expanded, which greatly limits the use of the blockchain system. Therefore, the blockchain system often puts the data content (such as the file) with high storage cost off the chain for storage, while the on-chain data only saves a hash value of the data content and a Uniform Resource Identifier (URI) for acquiring the content, so that the content is verified to ensure that the content is not tampered, and the content itself can also be acquired through the URI, which also greatly saves the cost of the on-chain storage space.

The embodiment can take into account the supervision of both on-chain and off-chain data, and different functional entities in the embodiment are responsible for processing the supervision of the on-chain and off-chain data. In an on-chain stage, both the on-chain data and the off-chain data of the on-chain block data are supervised by the monitoring node. When the block node returns the corresponding on-chain data to the client, the monitoring agent software deployed on the monitoring node performs supervision on the on-chain data. The specific process of the latter stage is described in the following embodiment.

In the embodiment, if at least one of the on-chain data and the off-chain data does not meet the compliance condition, it is determined that the on-chain block data does not meet the compliance condition. As long as any one of the on-chain data and the off-chain data is detected to be non-compliant, it is determined that the corresponding on-chain block data is non-compliant. For example, for the application scenario of detecting whether the on-chain data and the off-chain data contain sensitive information, in addition to the detection means and the compliance condition, the rule information further includes listed sensitive words, that is, a target text. The specific determination process is that: it is determined whether at least one of the on-chain data and the off-chain data contains a target text defined in the rule information according to a detection result, and if at least one of the on-chain data and the off-chain data contains the target text, it is determined that at least one of the on-chain data and the off-chain data does not meet the compliance condition.

At S23, if the on-chain block data does not meet the compliance condition, a corresponding non-compliance record is generated according to a detection result, and the non-compliance record is sent to the monitoring center, so that the monitoring center saves the non-compliance record in a local storage system.

In the embodiment, if the on-chain block data does not meet the compliance condition, the corresponding non-compliance record is generated according to the detection result, and the non-compliance record is sent to the monitoring center, so that the monitoring center saves the non-compliance record in the local storage system. When receiving an on-chain data message, the monitoring node first analyzes whether the on-chain data and the off-chain data are compliant (compliance means not hitting the supervision rule) by using the detection algorithm. If the data is found to be compliant, no subsequent processing is performed; and if the on-chain data or the off-chain data is found to be non-compliant, a non-compliance record report message is sent to the monitoring center. When receiving a non-compliance record report from the monitoring node, the monitoring center may save the record in the local solidified storage space for subsequent tracing of supervision records of the data. For example, the historical records of the non-compliant data may be traced back from a list of supervision event reports.

It can be seen that, in the embodiment of the present disclosure, the rule information sent by the monitoring center is first received, and the corresponding detection algorithm is determined according to the detection means defined in the rule information. Then, detection is performed on the on-chain data and the off-chain data of the on-chain block data by using the detection algorithm, respectively, and if at least one of the on-chain data and the off-chain data does not meet the compliance condition, it is determined that the on-chain block data does not meet the compliance condition. If the on-chain block data does not meet the compliance condition, the corresponding non-compliance record is generated according to the detection result, and the non-compliance record is sent to the monitoring center, so that the monitoring center saves the non-compliance record in the local storage system. When the data is on the chain, the embodiment of the present disclosure can take into account the supervision of the on-chain data and the off-chain data of the on-chain block data to avoid incomplete data supervision. At the same time, the records of the supervision center are saved, so that the non-compliant data is traceable and recoverable.

FIG. 4 is a specific flowchart of a blockchain monitoring method according to an embodiment of the present disclosure. Referring to FIG. 4, a blockchain monitoring method, applied to a monitoring node deployed in each of blockchains, includes the following operations.

At S31, rule information sent by a monitoring center is received, and the rule information is sent to a monitoring agent software deployed at a preset position of each of block nodes in the blockchain where the monitoring node is located.

In the embodiment, the monitoring node receives the rule information sent by the monitoring center and then sends the rule information to the a monitoring agent software deployed at the preset position of each of block nodes in the blockchain where the monitoring node is located. The preset position includes at least one of running device of the block node or at least one of device connected to an external network in a network where the block node is located. The monitoring agent software is also called a supervision Agent. The supervision Agent is a program, which may be directly deployed on at least one of running device of the block node associated therewith, or may be deployed on at least one of device (such as a firewall device) connected to the external network in the network where the associated block node is located. At this time, it is necessary to configure an Internet Protocol (IP) address of the associated node, a network port number for communicating with a terminal user, IP addresses of all the block nodes (that is, Peer nodes) interconnected to the associated node, and a key for encrypting the blockchain data of the associated node.

At S32, each sort of monitoring agent software determines the corresponding detection algorithm according to the detection means defined in the rule information and performs detection on the on-chain data sent to a client by the block node where the monitoring agent software is located by using the detection algorithm, so as to determine whether the on-chain data meets the compliance condition defined in the rule information.

In the embodiment, each monitoring agent software determines the corresponding detection algorithm according to the detection means defined in the rule information and performs detection on the on-chain data sent to the client by the block node where the monitoring agent software is located by using the detection algorithm. The determination process and the detection process of the detection algorithm are consistent with the detection process of the above-mentioned monitoring node on the on-chain block data, which will not be elaborated in the embodiment. It is to be noted that a detection object of the above-mentioned monitoring node is the on-chain block data, and the detection object of the monitoring agent software in the embodiment is on-chain data that has been on the chain and is sent by the block node to the corresponding client. Generally, the block node sends the chain data to the client in the form of a response data packet.

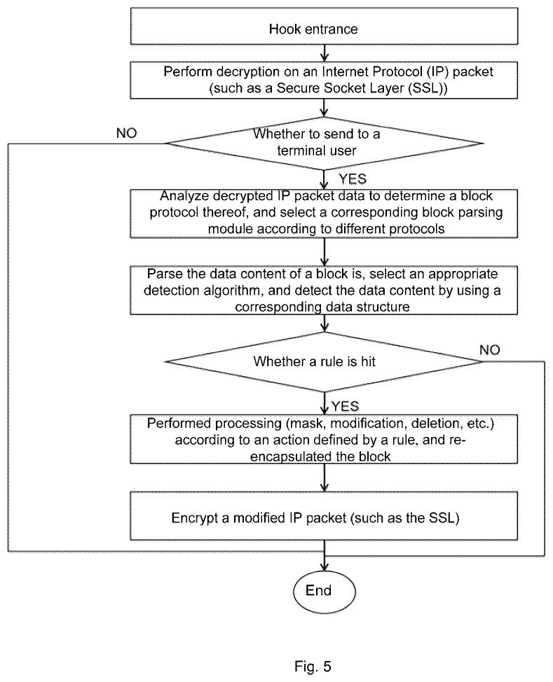

To this end, in the embodiment, after the client sends a data request to the block node, the block node generates a corresponding response data packet for the data request and returns same to the client. The response data packet is a response of the block node where the monitoring agent software is located to a data request of the client. In the return process, the monitoring agent software first intercepts the response data packet by means of a function hook and performs decryption on the response data packet, and then the monitoring agent software performs parsing on the decrypted response data packet to perform detection on the parsed response data packet by using the detection algorithm. The parsing process may be as follows: the monitoring agent software determines a block protocol of the decrypted response data packet, and determines a corresponding block parsing module according to the block protocol, so as to perform parsing on the decrypted response data packet by using the block parsing module. Finally, according to the detection result, it may be determined which response data packets are non-compliant, that is, the returned on-chain data is non-compliant. The above process is as shown in FIG. 5.

It is understandable that the existing blockchain system does not need to be modified, and does not interfere with the operation of the blockchain system. Only one associated supervision Agent needs to be deployed for each block node, and the supervision Agent may automatically intercept the data sent by the block node to the terminal user from a network port, detect the compliance of the data and mask the non-compliant data, which is completely transparent to the existing blockchain system.

At S33, the monitoring agent software performs processing on the on-chain data that does not meet the compliance condition according to a processing means defined in the rule information, so that the corresponding block node sends the processed on-chain data to the client.

In the embodiment, the monitoring agent software performs processing on the on-chain data that does not meet the compliance condition according to the processing means defined in the rule information, so that the corresponding block node sends the processed on-chain data to the client. The processing manner defined in the rule information may be at least one mask action, such as replacement, modification, deletion, etc. For data that is supervised and masked, the masked data may be recovered by modifying or deleting the corresponding supervision rule.

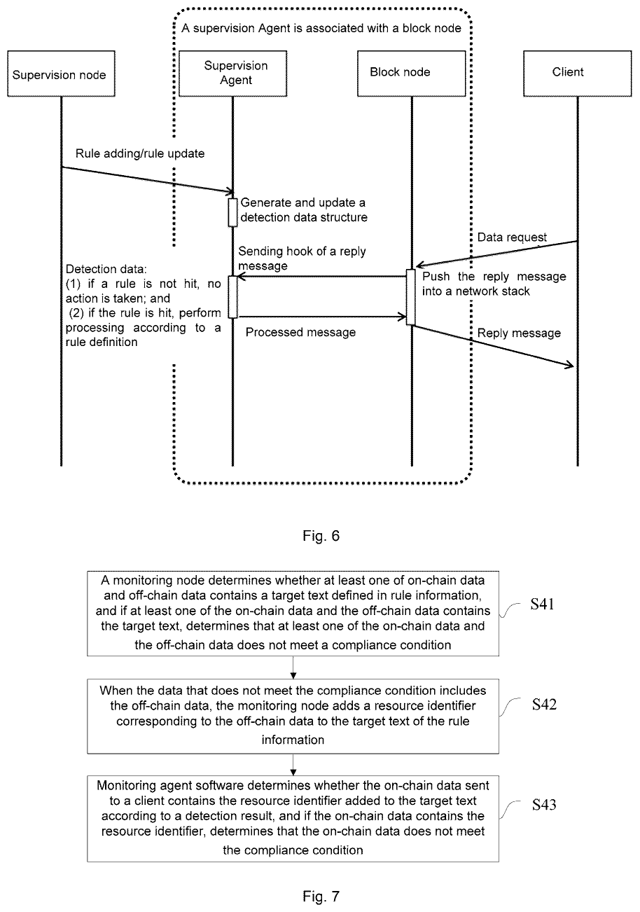

In summary, the message interaction between the supervision node and the supervision Agent in the embodiment is as shown in FIG. 6. After receiving the supervision rule, the supervision node may forward the supervision rule to all the supervision Agents of the blockchain where the supervision node is located. When receiving a rule adding or rule update rule message from the supervision node, the supervision Agent may select an applicable detection algorithm from the available detection algorithm pool according to the rule, and generate or update the corresponding data structure. The supervision Agent may intercept the message sent from the associated block node to the terminal user (client), and perform detection and analysis on the message content (on-chain data). When the data is compliant (that is, the rule is not hit), no subsequent processing is performed; and when the data is non-compliant (that is, the rule is hit), the message content is processed accordingly, and then the processed message is sent to the terminal user. In the above process, the on-chain data of the blockchain is not modified, and the blockchain structure is not destroyed. The non-compliant data is only subjected to mask processing before being sent by the block node to the terminal user through the network, and the on-chain data is not modified.

FIG. 7 is a specific flowchart of a blockchain monitoring method according to an embodiment of the present disclosure. Referring to FIG. 7, the blockchain monitoring method, applied to a monitoring node deployed in each of blockchains, includes the following operations.

At S41, the monitoring node determines whether at least one of on-chain data and off-chain data contains a target text defined in rule information according to a detection result, and if at least one of the on-chain data and the off-chain data contains the target text, determines that at least one of the on-chain data and the off-chain data does not meet a compliance condition.

At S42, when the data that does not meet the compliance condition includes the off-chain data, the monitoring node adds a resource identifier corresponding to the off-chain data to the target text of the rule information.

At S43, monitoring agent software determines whether the on-chain data sent to a client contains the resource identifier added to the target text according to the detection result, and if the on-chain data containing the resource identifier, determines that the on-chain data does not meet the compliance condition.

In the embodiment, the monitoring agent software performs detection on the on-chain data, in addition to determining whether the on-chain data itself contains the target text defined in the rule information, for the on-chain data containing the resource identifier such as a URI or a Uniform Resource Locator (URL), it is also necessary to determine whether the URI or the URL contained in the on-chain data is the corresponding off-chain data determined by the monitoring node when the on-chain data is on the chain.

Therefore, based on the above embodiment, when performing detection on the on-chain data and the off-chain data of the on-chain block data, the monitoring node specifically determines whether at least one of the on-chain data and the off-chain data contains the target text defined in the rule information according to the detection result, and if at least one of the on-chain data and the off-chain data contains the target text, determines that at least one of the on-chain data and the off-chain data does not meet the compliance condition. When the data that does not meet the compliance condition includes the off-chain data, the resource identifier corresponding to the off-chain data is added to the target text of the rule information.

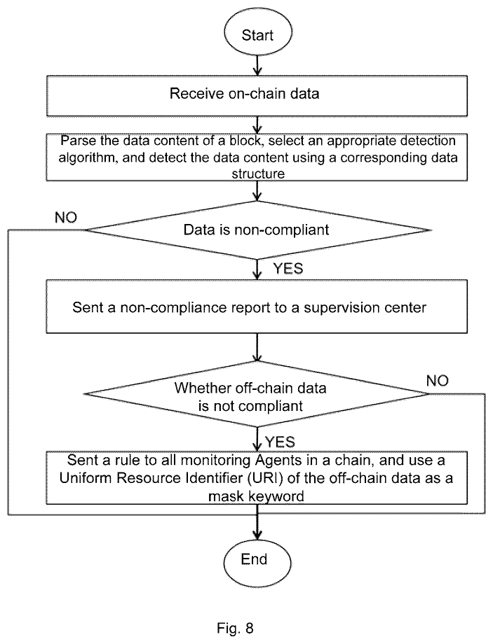

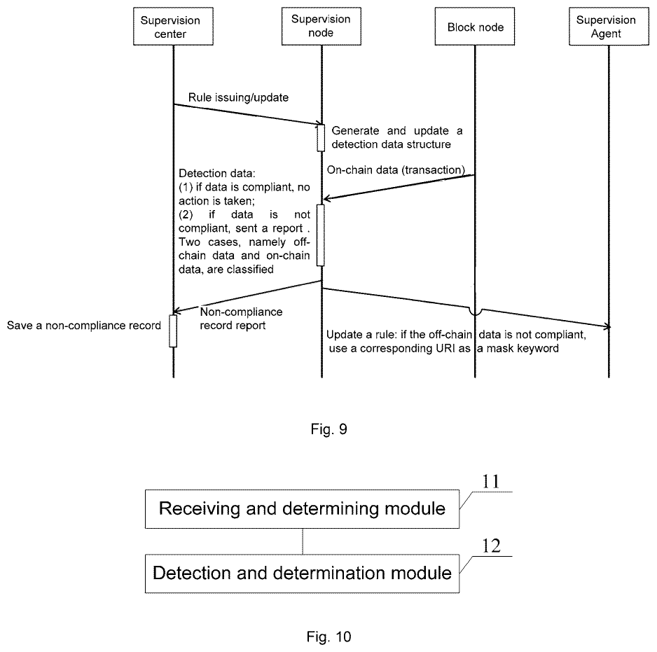

Generally, the monitoring node first detects the on-chain data, then detects the off-chain data, and broadcasts, if the off-chain data is non-compliant, a mask rule to all the supervision Agents in the blockchain where the monitoring node is located, where the URI or the URL corresponding to the off-chain data is used as a mask keyword. In this way, when receiving the target text after the addition operation sent by the monitoring node, the monitoring agent software can determine whether the on-chain data sent to the client contains the resource identifier added to the target text according to the detection result, and if the on-chain data contains the resource identifier, determines that the on-chain data does not meet the compliance condition. FIG. 8 is a specific processing flow of a monitoring node performing data detection based on the foregoing embodiment. FIG. 9 is an interaction process between a monitoring center, a monitoring node, and a monitoring Agent based on the foregoing embodiment.

The above method achieves adaptive supervision of heterogeneous alliance chains by using the supervision center, the supervision node, and the supervision Agents, performs detection on all the on-chain data and reports a non-compliance record, and masks non-compliant data. The method may be applied to the supervision of any blockchain, as long as the supervision node and the supervision Agent are deployed and configured in the current blockchain. In addition, the supervision node and the supervision agent can parse and encapsulate a block data structure by using a plug-in framework, and dynamically add a parsing and encapsulation module of a new block structure to adapt to any third-party blockchain system.

Referring to FIG. 10, the embodiments of the present disclosure further disclose a blockchain monitoring apparatus, applied to a monitoring node deployed in each of blockchains, including a receiving and determining module 11 and a detection and determination module 12.

The receiving and determining module 11 is configured to receive rule information sent by a monitoring center, and determine a corresponding detection algorithm according to a detection means defined in the rule information.

The detection and determination module 12 is configured to acquire on-chain block data, and perform detection on the on-chain block data by using the detection algorithm, so as to determine whether the on-chain block data meets a compliance condition defined in the rule information.

It can be seen that, in the embodiment of the present disclosure, the monitoring nodes deployed in the blockchains first receive the rule information sent by the monitoring center, and determine the corresponding detection algorithm according to the detection means defined in the rule information; and then acquire the on-chain block data, and perform detection on the on-chain block data by using the detection algorithm, so as to determine whether the on-chain block data meets the compliance condition defined in the rule information. In the embodiment of the present disclosure, the monitoring center arranged outside the blockchain exchanges data with the monitoring node deployed in the blockchain, the rule information is supervised and distributed in a unified manner by the monitoring center, and the monitoring node is adapted to the corresponding blockchain, so adapt access the blockchain, thereby solving the problem of incapability of achieving high-adaptability data supervision between heterogeneous blockchains, without the need for customized development of data monitoring functions for different blockchains and universality is high.

In some specific embodiments, the receiving and determining module 11 specifically includes a receiving unit and a determination unit.

The receiving unit is configured to receive rule information and change information sent by the monitoring center. The change information represents difference information between the rule information received by the monitoring node this time and rule information received last time.

The determination unit is configured to determine the corresponding detection algorithm from a detection algorithm pool deployed on the monitoring node according to the detection means defined in the rule information.

In some specific embodiments, the detection and determination module 12 is specifically configured to construct a data structure corresponding to the detection algorithm, and perform detection on the on-chain block data by using the data structure.

In some specific embodiments, the blockchain monitoring apparatus further includes a record generation and saving module.

The record generation and saving module is configured to generate, if the on-chain block data does not meet the compliance condition, a corresponding non-compliance record according to a detection result, and send the non-compliance record to the monitoring center, so that the monitoring center saves the non-compliance record in a local storage system.

In some specific embodiments, the detection and determination module 12 specifically includes a detection unit and a determination unit.

The detection unit is configured to perform detection on on-chain data and off-chain data of the on-chain block data by using the detection algorithm, respectively.

The determination module is configured to determine, if at least one of the on-chain data and the off-chain data does not meet the compliance condition, that the on-chain block data does not meet the compliance condition.

In some specific embodiments, the blockchain monitoring apparatus further includes a forwarding module.

The forwarding module is configured to send the rule information to a monitoring agent software deployed at a preset position of each of block nodes in the blockchain where the monitoring node is located, so that each sort of monitoring agent software determines the corresponding detection algorithm according to the detection means defined in the rule information and performs detection on the on-chain data sent to a client by the block node where the monitoring agent software is located by using the detection algorithm, so as to determine whether the on-chain data meets the compliance condition defined in the rule information.

In some specific embodiments, the determination unit is specifically configured to determine whether at least one of the on-chain data and the off-chain data contains a target text defined in the rule information according to a detection result, and if at least one of the on-chain data and the off-chain data contains the target text, determine that at least one of the on-chain data and the off-chain data does not meet the compliance condition.

In some specific embodiments, the blockchain monitoring apparatus further includes an adding module, a decryption module, a parsing module, and a preprocessing module.

The adding module is configured to add, when the data that does not meet the compliance condition includes the off-chain data, a resource identifier corresponding to the off-chain data to the target text of the rule information, so that the monitoring agent software determines whether the on-chain data contains the resource identifier added to the target text according to the detection result, and if the on-chain data contains the resource identifier, determine that the on-chain data does not meet the compliance condition.

The decryption module is configured to intercept, by the monitoring agent software, a response data packet by means of a function hook and decrypt the response data packet. The response data packet is a response of the block node where the monitoring agent software is located to a data request of the client.

The parsing module is configured to parse, by the monitoring agent software, the decrypted response data packet to perform detection on the parsed response data packet by using the detection algorithm.

The preprocessing module is configured to perform processing, by the monitoring agent software, on the on-chain data that does not meet the compliance condition according to a processing means defined in the rule information, so that the corresponding block node sends the processed on-chain data to the client.

In some specific embodiments, the parsing module is specifically configured to determine, by the monitoring agent software, a block protocol of the decrypted response data packet, and determine a corresponding block parsing module according to the block protocol, so as to perform parsing on the decrypted response data packet by using the block parsing module.

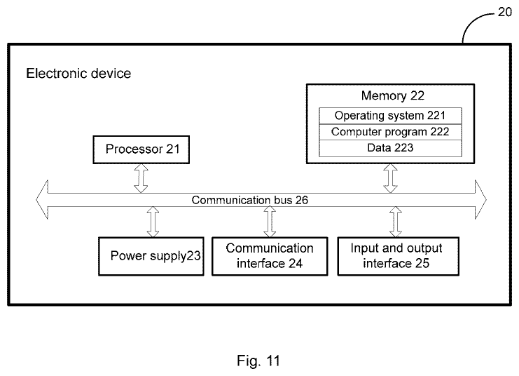

Further, the embodiments of the present disclosure further provide an electronic device. FIG. 11 is a structural diagram of an electronic device 20 according to an exemplary embodiment. The content in the figure cannot be considered as any limitation on the scope of the present disclosure.

FIG. 11 is a schematic structural diagram of an electronic device 20 according to an embodiment of the present disclosure. The electronic device 20 may specifically include: at least one processor 21, at least one memory 22, a power supply 23, a communication interface 24, an input and output interface 25, and a communication bus 26. The memory 22 is configured to store a computer program, and the computer program is loaded and executed by the processor 21 to implement the relevant steps in the blockchain monitoring method disclosed in any of the foregoing embodiments.

In the embodiment, the power supply 23 is configured to provide operating voltage for each hardware device on the electronic device 20. The communication interface 24 can create a data transmission channel with an external device for the electronic device 20, and the communication protocol followed is any communication protocol that can be applied to the technical solution of the present disclosure, which is not specifically limited here. The input and output interface 25 is configured to acquire external input data or to output data to the outside, and the specific interface type may be selected according to specific application needs, which is not specifically limited here.

In addition, the memory 22, as a carrier for resource storage, may be a read only memory, a random access memory, a magnetic disk or a compact disc (CD), etc., resources stored thereon may include an operating system 221, a computer program 222, data 223, etc., and the storage manner may be transient storage or permanent storage.

The operating system 221 is configured to manage and control each hardware device and the computer program 222 on the electronic device 20 to implement the calculation and processing of massive data 223 in the memory 22 by the processor 21, and may be Windows Server, Netware, Unix, Linux, etc. In addition to a computer program that can be configured to complete the blockchain monitoring method executed by the electronic device 20 disclosed in any of the foregoing embodiments, the computer program 222 may further include computer programs that can be configured to complete other specific tasks. The data 223 may include data such as rule information collected by the electronic device 20.

Further, the embodiments of the present disclosure further disclose a storage medium, in which a computer program is stored, and the computer program is loaded and executed by a processor to implement the steps of the blockchain monitoring method disclosed in any of the foregoing embodiments.

The various embodiments in the present specification are described in a progressive manner, and each embodiment focuses on differences from other embodiments, and the same or similar parts between the various embodiments may be referred to each other. For the apparatus disclosed in the embodiment, since it corresponds to the method disclosed in the embodiment, the description is relatively simple, and the relevant parts can be referred to the method part.

Finally, it is to be noted that relational terms such as first, second, and the like herein are adopted only to distinguish one entity or operation from another entity or operation and not always to require or imply existence of any such practical relationship or sequence between the entities or operations. Furthermore, terms “include” and “contain” or any other variant thereof is intended to cover nonexclusive inclusions herein, so that a process, method, object or device including a series of elements not only includes those elements but also includes other elements which are not clearly listed or further includes elements intrinsic to the process, the method, the object or the device. Under the condition of no more limitations, an element defined by the statement “including a/an . . . ” does not exclude existence of the same other elements in a process, method, object or device including the element.

The blockchain monitoring method and apparatus, the device, and the storage medium provided in the present disclosure are described in detail above. The principles and implementations of the present disclosure are described herein using specific examples, the foregoing description of the examples are only used to help the understanding of the method and core concept of the present disclosure. At the same time, for those of ordinary skill in the art, according to the concept of the present disclosure, there will be changes in the specific implementation modes and the application scope. In summary, the contents of the present description should not be construed as limiting the present disclosure.

1. A blockchain monitoring method, applied to a monitoring node deployed in each of blockchains, comprising:
receiving rule information sent by a monitoring center, and determining a corresponding detection algorithm according to a detection means defined in the rule information; and
acquiring on-chain block data, and performing detection on the on-chain block data by using the detection algorithm, so as to determine whether the on-chain block data meets a compliance condition defined in the rule information.

2. The blockchain monitoring method according to claim 1, wherein the determining a corresponding detection algorithm according to a detection means defined in the rule information comprises:
determining the corresponding detection algorithm from a detection algorithm pool deployed on the monitoring node according to the detection means defined in the rule information.

3. The blockchain monitoring method according to claim 1, wherein the performing detection on the on-chain block data by using the detection algorithm comprises:
constructing a data structure corresponding to the detection algorithm, and performing detection on the on-chain block data by using the data structure.

4. The blockchain monitoring method according to claim 3, wherein the receiving rule information sent by a monitoring center comprises:
receiving the rule information and change information sent by the monitoring center, wherein the change information represents difference information between the rule information received by the monitoring node this time and rule information received last time; and
accordingly, the constructing a data structure corresponding to the detection algorithm comprises:
determining a changed detection algorithm according to the change information, and updating the data structure based on the changed detection algorithm.

5. The blockchain monitoring method according to claim 1, wherein the performing detection on the on-chain block data by using the detection algorithm comprises:
in a case where the monitoring node has already constructed the data structure, performing detection on the on-chain block data by using the constructed data structure.

6. The blockchain monitoring method according to claim 1, after determining whether the on-chain block data meets the compliance condition defined in the rule information, comprising:
in response to the on-chain block data not meeting the compliance condition, generating a corresponding non-compliance record according to a detection result, and sending the non-compliance record to the monitoring center, so that the monitoring center saves the non-compliance record in a local storage system.

7. The blockchain monitoring method according to claim 1, wherein the performing a detection on the on-chain block data by using the detection algorithm comprises at least one of the following:
performing sensitive word detection on the on-chain block data by using a text matching algorithm, wherein the compliance condition comprises that the on-chain block data does not contain specified sensitive words; and
performing sensitive image detection on the on-chain block data by using an image detection algorithm, wherein the compliance condition comprises that the on-chain block data does not contain sensitive images.

8. The blockchain monitoring method according to claim 1, wherein the performing detection on the on-chain block data by using the detection algorithm, so as to determine whether the on-chain block data meets a compliance condition defined in the rule information comprises:
performing detection on on-chain data and off-chain data of the on-chain block data by using the detection algorithm, respectively, and in response to at least one of the on-chain data and the off-chain data not meeting the compliance condition, determining that the on-chain block data does not meet the compliance condition.

9. The blockchain monitoring method according to claim 8, before performing detection on the on-chain data and the off-chain data of the on-chain block data by using the detection algorithm, respectively, comprising:
determining a data content of the on-chain block data as the off-chain data, and determining a hash value of the data content and a Uniform Resource Identifier (URI) for acquiring the data content as the on-chain data.

10. The blockchain monitoring method according to claim 8, comprising:
sending the rule information to a monitoring agent software deployed at a preset position of each of block nodes in the blockchain where the monitoring node is located, so that each monitoring agent software determines the corresponding detection algorithm according to the detection means defined in the rule information, and performs detection on the on-chain data sent to a client by the block node where the monitoring agent software is located by using the detection algorithm, so as to determine whether the on-chain data meets the compliance condition defined in the rule information.

11. The blockchain monitoring method according to claim 10, wherein the preset position comprises at least one running device of the block node or at least one device connected to an external network in a network where the block node is located.

12. The blockchain monitoring method according to claim 11, wherein the determining whether the on-chain block data meets a compliance condition defined in the rule information comprises:
determining whether at least one of the on-chain data and the off-chain data contains a target text defined in the rule information according to a detection result, and in response to at least one of the on-chain data and the off-chain data containing the target text, determining that at least one of the on-chain data and the off-chain data does not meet the compliance condition.

13. The blockchain monitoring method according to claim 12, after determining that at least one of the on-chain data and the off-chain data does not meet the compliance condition, comprising:
in response to data that does not meeting the compliance condition comprises the off-chain data, adding a resource identifier corresponding to the off-chain data to the target text of the rule information, so that the monitoring agent software determines whether the on-chain data contains the resource identifier added to the target text according to the detection result, and in response to the on-chain data containing the resource identifier, determining that the on-chain data does not meet the compliance condition.

14. The blockchain monitoring method according to claim 13, after determining that the on-chain data does not meet the compliance condition, comprising:
performing, by the monitoring agent software, processing on the on-chain data that does not meet the compliance condition according to a processing means defined in the rule information, so that a corresponding block node sends a processed on-chain data to the client.

15. The blockchain monitoring method according to claim 14, wherein the performing, by the monitoring agent software, processing on the on-chain data that does not meet the compliance condition according to a processing means defined in the rule information comprises:
performing, by the monitoring agent software, processing on the on-chain data that does not meet the compliance condition according to at least one mask action defined in the rule information, wherein the mask action comprises at least one of the following: replacement, modification, and deletion.

16. The blockchain monitoring method according to claim 10, comprising:
intercepting, by the monitoring agent software, a response data packet by means of a function hook and performing decryption on the response data packet, wherein the response data packet containing the on-chain data is a response of the block node where the monitoring agent software is located to a data request of the client; and
performing, by the monitoring agent software, parsing on the decrypted response data packet to perform detection on the parsed response data packet by using the detection algorithm.

17. The blockchain monitoring method according to claim 16, wherein the performing, by the monitoring agent software, parsing on the decrypted response data packet comprises:
determining, by the monitoring agent software, a block protocol of the decrypted response data packet, and determining a corresponding block parsing module according to the block protocol, so as to perform parsing on the decrypted response data packet by using the block parsing module.

18. (canceled)

19. An electronic device, comprising a processor and a memory, wherein the memory is configured to store a computer program, and the computer program is loaded and executed by the processor to implement following actions:
receiving rule information sent by a monitoring center, and determining a corresponding detection algorithm according to a detection means defined in the rule information; and
acquiring on-chain block data, and performing detection on the on-chain block data by using the detection algorithm, so as to determine whether the on-chain block data meets a compliance condition defined in the rule information.

20. A computer non-volatile readable storage medium, configured to store a computer executable instruction, wherein the computer executable instruction is loaded and executed by a processor to implement following actions:
receiving rule information sent by a monitoring center, and determining a corresponding detection algorithm according to a detection means defined in the rule information; and
acquiring on-chain block data, and performing detection on the on-chain block data by using the detection algorithm, so as to determine whether the on-chain block data meets a compliance condition defined in the rule information.

21. The blockchain monitoring method according to claim 1, wherein the rule information is stored on a disk of the supervision center in the form of a database or a file, and at least defines the detection means and the compliance condition.
